(19) United States
(12) Patent Application Publication
(10) Pub. No.: US 2009/0145618 A1
(43) Pub. Date: Jun. 11, 2009

(54) ROTARY HAMMER

(76) Inventors: Achim Duesselberg, Hangzhou (CN); Andre Ullrich, Filderstadt-Bernhausen (DE); Kurt Sieber, Leinfelden-Echterdingen (DE); Thomas Brinkmann, Filderstadt (DE)

Correspondence Address: MICHAEL J. STRIKER, 103 EAST NECK ROAD, HUNTINGTON, NY, 11743, US

(21) Appl. No.: 11/719,828

(22) PCT Filed: Jul. 24, 2006
(86) PCT No.: PCT/EP06/64565

§ 371 Date: May 21, 2007

(30) Foreign Application Priority Data
Aug. 31, 2005 (DE) 10 2005 041 447.8

(51) Int. Cl. B25D 16/00

(52) U.S. Cl. 173/48; 173/216

(57) ABSTRACT

Disclosed is a drill hammer (10) comprising a half shell-type housing (12) that accommodates the parts mentioned below, a motor (16) with an on-off switch (18) and a motor shaft (22) with a motor pinion (24), a gear mechanism (26) with an intermediate shaft (28), a driving gear (30), an entrained gear (32) with a shifting sleeve (34), and an output gear (35), an impact mechanism (36) with a swashplate (40), an eccentric gear (38) with an eccentric finger (42), and an impact element (44), as well as an output shaft (46) with a driving gear (48) and a drill chuck (50). The motor (16) meshes with the driving gear (30) of the intermediate shaft (28) via the motor pinion (24) thereof. The rotary movement of the motor (16) can be alternatively adjusted to an exclusively rotary movement, an exclusive lifting movement, or a rotary lifting movement of the output shaft (46) by means of the gear mechanism (26) by displacing the shifting sleeve (34) with the aid of shifting means (52). In order to be able to produce said drill hammer (10) at low cost while making the same operate at great efficiency, the intermediate shaft (28) is embodied as a simple, preferably smooth, cylindrical part on which the driving gear (30), the entrained gear (32), which is made especially of sintered metal, and the antifriction bearing (45) sit in a torsion-proof manner, particularly being pressed thereupon, and are used as an axial securing element for the eccentric gear (38) freewheeling on the intermediate shaft (28) and the output gear (35).

### RELATED ART

The present invention relates to a rotary hammer according to the preamble of Claim 1.

A rotary hammer is made known in EP 1 157 788, which has a transmission with which the operating modes of drilling, chiseling and percussion drilling can be selected by displacing a single shifting sleeve.

The transmission of the known rotary hammer has a relatively complicated design, and its efficiency is reduced via the permanent friction of the switching mechanism.

### ADVANTAGES OF THE INVENTION

The present invention with the features of claim 1 has the advantage that a rotary hammer is attained that is designed in a simple, cost-favorable manner, the efficiency of which is not impaired by the switching mechanisms in the transmission.

Given that the intermediate shaft is a simple, cylindrical part on which the driving gear, the entrained gear—which is composed of sintered metal in particular—and the antifriction bearing are non-rotatably mounted, and are pressed-on in particular, and which serve to axially secure the wobble gear—which is capable of freewheeling on the intermediate shaft—and the output gear, the rotary hammer is cost-favorable to manufacture, and it is robust.

Given that its shifting sleeve has an internal spline profile that meshes with the entrained gear, the wobble gear, and the output gear—each of which has a splined shaft profile—in a displaceble and rotationally driving manner, the transmission is easily shifted.

Given that the diameter and splines of the entrained gear match the diameter and splines of the adjacent wobble gear and at least a partial section of the output gear, the individual pieces are cost-favorable to manufacture, since they have the same toothing.

Given that the shifting sleeve is approximately 20 mm wide and is therefore approximately 10 mm wider than the entrained gear, the contact gap for changing the switch setting need be only approximately 5 mm shorter, when the transmission has a compact design.

Given that the shifting sleeve, when centrally located relative to the entrained gear, extends past the entrained gear on both sides by nearly the same length and is simultaneously engaged with the adjacent gears, i.e., the wobble gear and the output gear, the switch setting for carrying out percussion drilling with a rotary and reciprocating motion of the output shaft is easy to select.

Given that the shifting sleeve encloses the entrained gear in a non-rotatable and axially displaceable manner and can be selectively displaced axially to either side using the adjacent gears such that it engages in the adjacent gears in a form-fit manner, so that it—when in the central position—is engaged simultaneously with the wobble gear and the output gear, or it meshes—in one of the two lateral displacement positions—exclusively with the wobble gear or exclusively with the output gear, it is possible to easily switch between the operating modes of the rotary hammer, i.e., between percussion drilling, chiseling, and drilling.

Given that the shifting sleeve—which is composed of sintered metal in particular—includes an annular groove-type slot on its outer circumference in which an engaging fork serving as switching means engages, simple switching means can be used to shift the transmission.

Given that the engaging fork—except during gear shifts—engages in the slot of the shifting sleeve in a zero-force and, therefore, frictionless manner, the frictional losses are low and the efficiency of the rotary hammer is improved.

Given that each of the teeth in the splined shaft profile of the wobble gear and the output gear has—on its side facing the entrained gear—a partial tooth width reduction of approximately 1 to 2 mm, which results in a partial widening of the tooth gaps in the splined shaft profile—the tooth gaps serving as synchronizing recesses—switching is facilitated, as is entry by the teeth of the internal splines of the shifting sleeve into the tooth gaps of the splined shaft profiles.

Given that each of the teeth in the splined shaft profile of the shifting sleeve has a partial tooth width reduction of approximately 1 to 2 mm, and the teeth in the splined shaft profile of the wobble gear and the output gear have no tooth width reduction, a synchronizing aid is attained that is based exclusively on the design of the shifting sleeve, thereby reducing the manufacturing expenditure for the transmission.

Given that an intermediate flange is mounted between the motor and the transmission, in which an end of the intermediate shaft is rotatably mounted, particularly via a needle bearing, the housing—which is composed of plastic half shells—is particularly deformation-resistant and stable.

Given that a single-piece, particularly U-bent shift plate serves as shifting means, one of the U-legs of which serves as an engaging fork and the other U-leg of which serves as a locking fork, the switching mechanism is particularly easy to manufacture.

Given that the locking fork has an internal spline profile, via which it—particularly in the switch setting for the exclusively reciprocating motion of the transmission—is engageable with the splined shaft profile of the output gear, thereby locking it in position, it is possible—using a single, extremely simple machine element—to switch the transmission into the chiseling mode, i.e., an exclusively reciprocating motion of the transmission, with the rotary position of the output shaft being simultaneously locked in place.

### DRAWING

The present invention is explained in greater detail below with reference to an exemplary embodiment and the drawing.

FIG. 1 shows an exploded view of the inventive rotary hammers.

FIG. 2 is a side view of the rotary hammer, with a half shell removed.

FIG. 3 is a spacial view of the transmission of the rotary hammer.

FIG. 4 is a side view of the transmission in FIG. 3.

FIGS. 5a and 5b are spacial views of the auxiliary unit of the rotary hammer.

FIG. 6 is a spacial view of the transmission, the impact mechanism, and the motor of the rotary hammer.

FIGS. 7a and 7b are a sectional view and a spacial view of the shifting sleeve.

FIGS. 8a and 8b are a sectional view and a spacial view of the entrained gear.

FIG. 9 is a spacial view of the intermediate shaft with the driving gear and entrained gear.

FIG. 10 is a spacial view of the intermediate shaft with the driving gear, the entrained gear, and the antifriction bearing.

FIG. 11 is a spacial view of the wobble gear with swash plate and wobble finger.

FIG. 11 is a spacial view of the output gear of the intermediate shaft, and

FIG. 13 is a side view of the output gear.

### DESCRIPTION

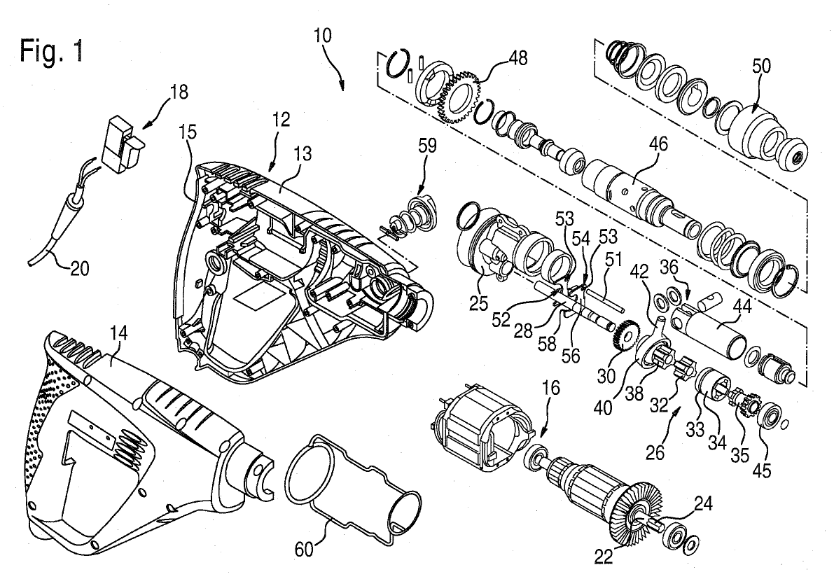

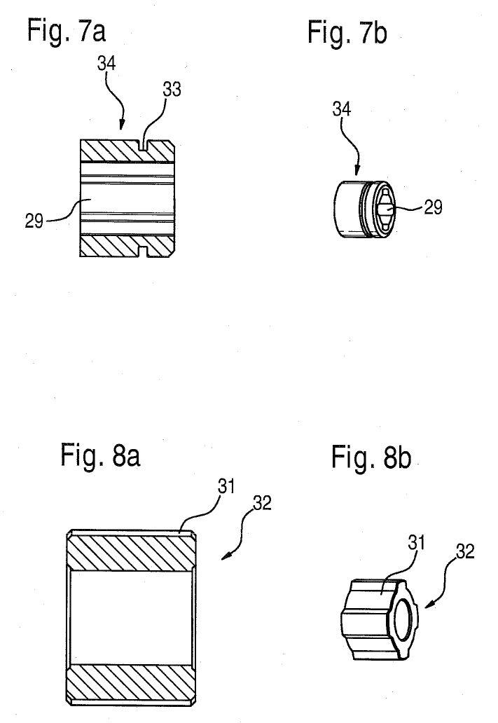

The exploded view in FIG. 1 shows a rotary hammer 10 with a housing 12 composed of two plastic half shells 13, 14 with a vertical parting line. Housing 12 accommodates a motor 16 with an on/off switch 18 and an electrical cable 20 for connection to an external current source, and a transmission 26 and an impact mechanism 36. Motor 16 contains a motor shaft 22, on the free end of which a motor pinion 24 is installed, and which is supported in an intermediate flange 25, which can be secured in the correct position between half shells 13, 14. Motor pinion 24 is engaged with a driving gear 30 of an intermediate shaft 28 of transmission 26 supported at one end via a not-shown needle bearing in intermediate flange 25. A wobble gear 38 is rotatably mounted on intermediate shaft 28, adjacent to driving gear 30, which is fixedly mounted on intermediate shaft 28, it having been preferably pressed thereon. A swash plate 40 with wobble finger 42 are mounted on wobble gear 38, as part of impact mechanism 36. Axially adjacent to wobble gear 38, an entrained gear 32 is non-rotatably mounted on intermediate shaft 28—it having been preferably pressed thereon—followed axially by an output gear 35, which is secured axially by an antifriction bearing 45 fixedly mounted on the other end of intermediate shaft 28; splined shaft profile 31 of entrained gear 32 is enclosed by toothed spline profile 29 of a shifting sleeve 34 (FIGS. 7a, 7b) in a rotationally driveable and axially displaceable manner. Output gear 35 of intermediate shaft 28 meshes with driving gear 48 of output shaft 46. Transmission 26 is used—by displacing shifting sleeve 34 with shifting means 52- to selectively adjust the rotary motion of motor 16 to perform an exclusively rotary motion of output shaft 46, i.e., drilling, to perform an exclusively reciprocating motion of the impact mechanism without rotation of output shaft 46, i.e., chiseling, or to perform a rotary-reciprocating motion, i.e., percussion drilling.

Adjacent to wobble finger 42, impact mechanism 35 extends into an impact element 44 that transfers the impact energy—which has been converted into a translatory motion from a rotary motion via swash plate 40- to an impact part—which is not described in greater detail—inside output shaft 46 and, therefore, to a not-shown drill or chisel mounted on its end and retained therein in a drill chuck 50.

Shifting sleeve 34 includes, in its circumference, an annular groove-type slot in which an engaging fork 52 is capable of engaging; engaging fork 52 is part of a switch plate 54 designed as a single-piece, bent sheet-metal piece in particular. Switch plate 54 is a U-bent sheet-metal piece, the first U-leg of which encloses—via a semi-circular recess 57—shifting sleeve 34, and/or engages in its slot 33, and the second U-leg of which serves as locking fork 56 and is provided with an internal spline profile 58 located in a semicircular recess for engaging in splined shaft profile 31 of output gear 35. When the aforementioned engagement takes place, output gear 35 is simultaneously released from rotary engagement via shifting sleeve 34 and locked in a non-rotatable position. In this manner, it is possible to lock in a selected rotary position of output shaft 46 in order to perform a chiseling operation. Switch plate 54 is displaceable longitudinally, axially parallel with intermediate shaft 28—via a guide rod 51 which, to this end, passes through a guide bore 53 that extends transversely through engaging fork 52 and locking fork 56. A rotary knob-type switch element 59 is used to displace switch plate 54 on guide rod 51, the rotation of which—via its eccentric cam 74—is transferable as a sliding motion to a projection 55 of switch plate 54, as indicated by rotational direction-arrow 72. To this end, switch element 59 is centered in its central position using a leg spring 76. Leg spring 76 encloses, via its legs 78, eccentric cam 74 serving as switch element, and retains it in its central position, which defines the percussion drilling mode. Simultaneously, legs 78 enclose projection 55 of switch plate 54, which extends between legs 78 in the manner of a tab. Legs 78 carry switch plate 54 along when switch element 59 is actuated.

The rotary motion of electric motor 16 is transferred via driving gear 30 to intermediate shaft 28. Entrained gear 32 composed of sintered metal has the shape of a splined shaft, the profile of which extends along its entire outer length. Wobble gear 38 is capable of being non-rotatably coupled via shifting sleeve 34 with entrained gear 32; the rotary motion of intermediate shaft 28 is then converted via swash plate 40 and wobble finger 42 into a translatory motion of impact element 44.

Output gear 35—which is rotatably mounted on intermediate shaft—is capable of being non-rotatably coupled via shifting sleeve 34 with entrained gear 32; a portion of output gear 35 has a splined shaft profile 66 that corresponds with the internal spline profile of shifting sleeve 34, and a further portion of output gear 35 has spur gear profile 68 for transferring rotation to driving gear 48 of output shaft 46. As a result, the rotary motion of intermediate shaft 28 is transferable to output shaft 46 and drill chuck 50 mounted thereon and/or an insertion tool in the form of a drill or a chisel installed therein. The coupling and/or switching between entrained gear 32 to axially adjacent wobble gear 38 or output gear 35 takes place via shifting sleeve 34, the positioning of which is carried out exclusively via the form-fit connection between slot 33 and engaging fork 52 engaged therein, without frictional losses taking place when rotary hammer 10 is operated. Shifting sleeve 34 therefore remains in any of the three switching positions without axial application of force, thereby resulting in reduced wear and longer service life.

When, due to the axial displacement of switching sleeve 34, the matching splined shaft/internal spline profiles of wobble gear 38 or output gear 35 mesh with the profile of shifting sleeve 34 on the face, switch-synchronizing means facilitate the switch. To this end, the splined shaft profiles of wobble gear 38 or output gear 35 each have—on their side facing entrained gear 32—a partial tooth width reduction 62, 64 of approximately ⅔ of the tooth width along a tooth length of approximately 1 to 2 mm. This results in a partial widening of the tooth gaps in the splined shaft profile, thereby making it easier for the internal splines of switching sleeve 34 to engage with the splined shaft profile.

As an alternative, each of the teeth in the internal spline profile of shifting sleeve 34 can have a partial tooth width reduction 70 of approximately 1 to 2 mm on both end faces; the teeth in the splined shaft profiles of wobble gear 38 and output gear 35 do not have to have tooth width reduction. The synchronizing means are therefore realized in a single component, and the manufacturing costs of the rotary hammer are reduced further.

In a transition position when switching from the percussion drilling mode to the chiseling mode, drill chuck 50 and/or the chisel can be rotated manually into a desired working position. After switching into the “chisel mode” switch position, the selected rotary position of the chisel is retained via the locking accomplished with locking fork 56.

The contact gap is approximately 5 mm of displacement travel by shifting sleeve 34 or rotational displacement of switch element 59 to the right or the left, i.e., it is conveniently short.

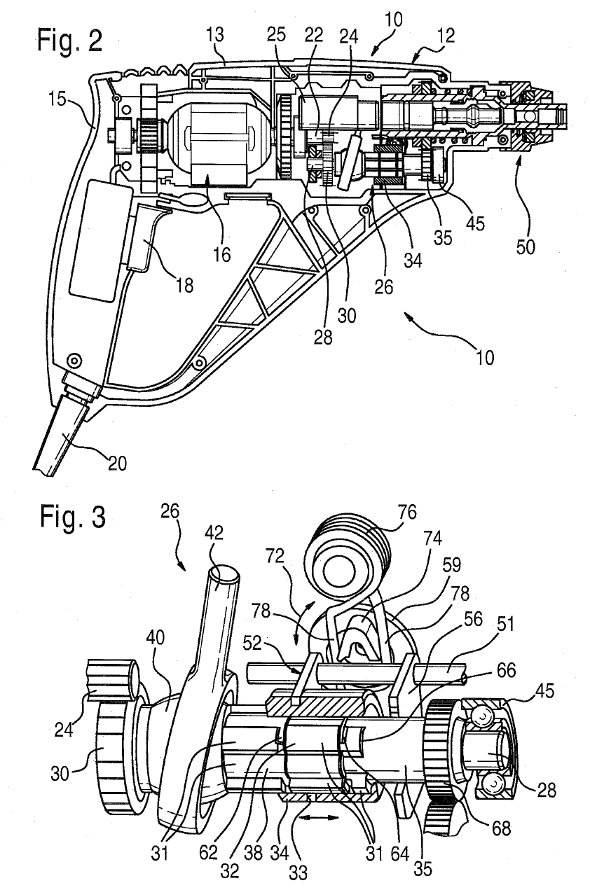

The side view of rotary hammer 10 shown in FIG. 2 with open half shell 13 shows the layout of motor 16, transmission 26 and impact mechanism 36, thereby providing a view of the element structure described with reference to FIG. 1.

The spacial view of transmission 26 of rotary hammer 10 depicted in FIG. 3 shows the details of the illustration and description for FIG. 1.

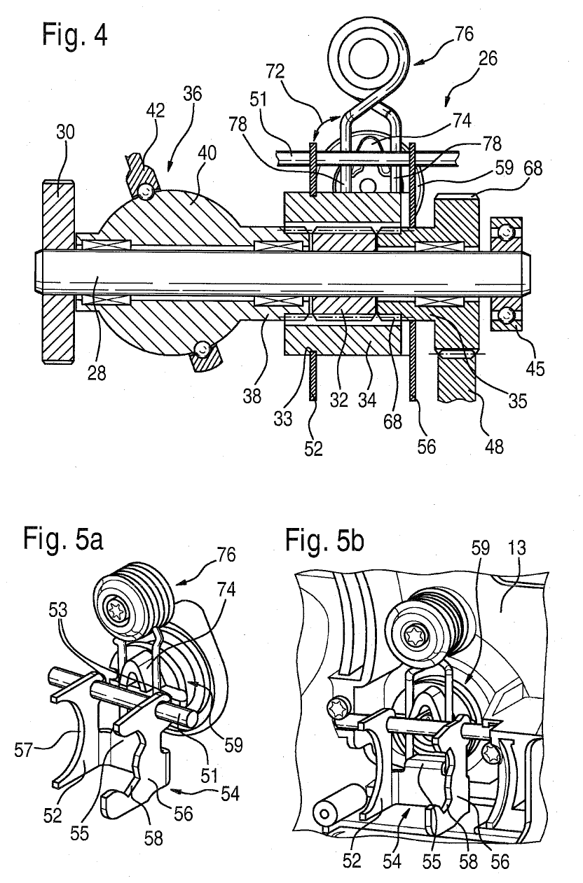

The side view of transmission 26 in FIG. 3 shown in FIG. 4 serves to provide further detail to the description of FIG. 1.

The switch elements used to shift transmission 26 of rotary hammer 10 shown in FIGS. 5a and 5b serve to illustrate the functionalities described with reference to FIG. 1.

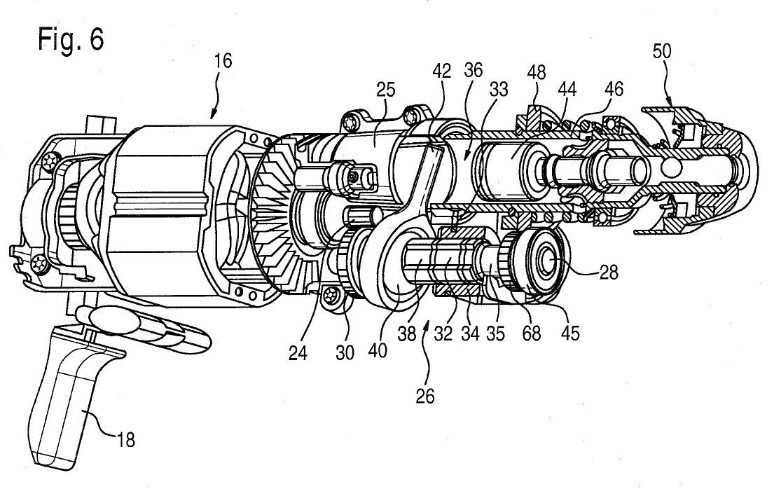

The spacial view shown in FIG. 6 shows transmission 26, impact mechanism 36, and motor 16 of rotary hammer 10 in the assembled state.

The spacial view and side view of shifting sleeve 34 shown in FIGS. 7a and 7b provide greater detail about their design explained with reference to FIG. 1 and show internal spline profile 29 and slot 33 particularly clearly.

The spacial depiction and sectional view of entrained gear 32 in FIGS. 8a and 8b serve to provide further detail about their design described with reference to FIG. 1.

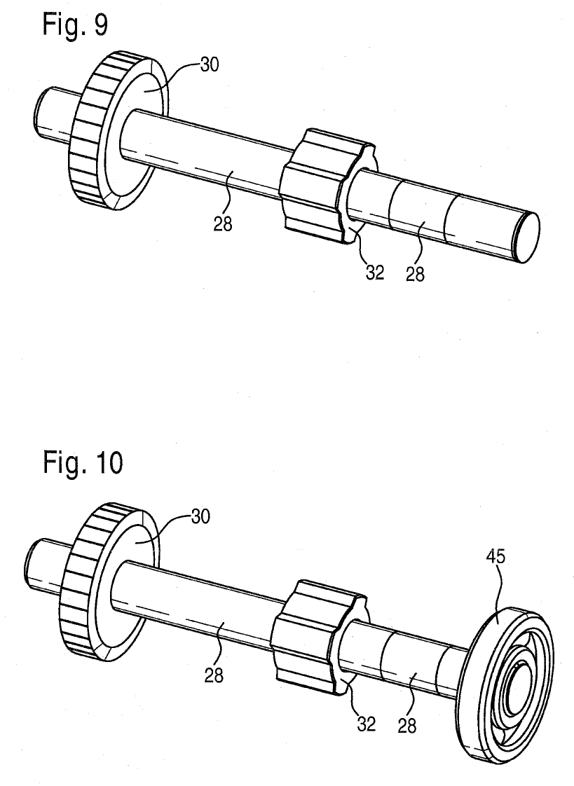

The spacial view of intermediate shaft 28 with driving gear 30 and entrained gear 32 according to FIG. 9, and their spacial view shown in FIG. 10 with driving gear 30, entrained gear 32 and antifriction bearing 45 serve to provide further detail about their design described with reference to FIG. 1.

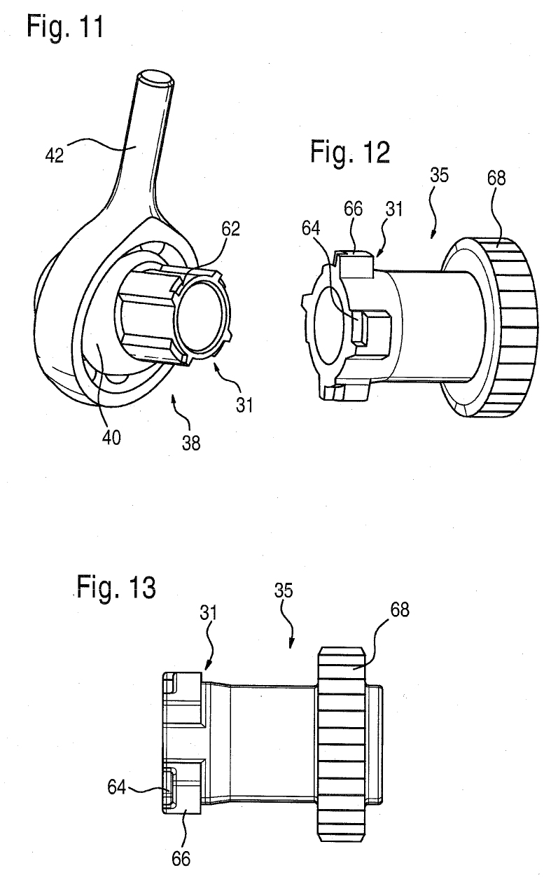

The spacial depiction of wobble gear 38 with swash plate 40 and wobble finger 42 in FIG. 11, and the spacial depiction of output gear 35 shown in FIG. 12 provide further detail about the design of the tooth profiles and their synchronizing means 62, 64, 66 in particular.

Output gear 35 of intermediate shaft 28 shown in FIG. 13 serves to clarify the details described with reference to FIG. 1, particularly their tooth profiles and the synchronizing means.

What is claimed is:

1. A rotary hammer (10) with a transmission (26) with an intermediate shaft (26), a driving gear (30), an entrained gear (32) with a shifting sleeve (34), an output gear (35), an impact mechanism (36), an output shaft (46) with a driving gear (48), and at least one antifriction bearing (45); it is possible to alternately select an exclusively rotary motion, an exclusively reciprocating motion, or a rotary-reciprocating motion of the output shaft (46) by displacing the shifting sleeve (34),
wherein
the intermediate shaft (28) is a simply—preferably smooth—cylindrical part on which the driving gear (30), the entrained gear (32)—which is preferably composed of sintered metal—and the antifriction bearing (45) are non-rotatably mounted, having been pressed thereupon in particular, and serve to axially secure gear wheels that are capable of freewheeling on the intermediate shaft (28), particularly a wobble gear (38) and the output gear (35).

2. The rotary hammer as recited in claim 1,
wherein
its housing (12) is a half shell-type housing.

3. The rotary hammer as recited in claim 1,
wherein
its shifting sleeve (34) has an internal spline profile (29), which fits with the entrained gear (32), the output gear (35), and a wobble gear (38)—each of which has a splined shaft profile (31)—in a displaceable and rotationally driving manner.

4. The rotary hammer as recited in claim 1,
wherein
the diameter and splines of the entrained gear (32) match the diameter and splines of the adjacent wobble gear (38) and at least a partial section of the output gear (35).

5. The rotary hammer as recited in claim 1,
wherein
the shifting sleeve (34) is approximately 20 mm wide, thereby making it approximately 10 mm wider than the entrained gear (32).

6. The rotary hammer as recited in claim 1,
wherein
the shifting sleeve (34), when centrally located relative to the entrained gear (32), extends past the entrained gear (32) on both sides by nearly the same length and is simultaneously engaged with the adjacent gears, i.e., the wobble gear (38) and the output gear (35).

7. The rotary hammer as recited in claim 1,
wherein
its shifting sleeve (34) encloses the entrained gear (32) in a non-rotatable and axially displaceable manner and can be selectively displaced axially to either side using the adjacent gears such that it engages in the adjacent gears in a form-fit manner; when the shifting sleeve (34) is in the central position, it is therefore engaged simultaneously with the wobble gear (38) and the output gear (35), or it is meshed—in one of the two lateral displacement positions—either exclusively with the wobble gear (38) or exclusively with the output gear (35).

8. The rotary hammer as recited in claim 1,
wherein
the shifting sleeve (34), which is composed of sintered metal in particular, includes an annular groove-type slot (33) on its outer circumference in which an engaging fork (52) serving as a shifting means engages.

9. The rotary hammer as recited in claim 8,
wherein
the engaging fork (52) engages—except during gear shifts—in the slot (33) and shifting sleeve (34) in a zero-force and, therefore, frictionless manner.

10. The rotary hammer as recited in the preamble of claim 1,
wherein
each of the teeth in the splined shaft profile of the wobble gear (38) and the output gear (35) has—on its side facing the entrained gear (32)—a partial tooth width reduction of approximately 1 to 2 mm, which results in a partial widening of the tooth gaps in the splined shaft profile—the tooth gaps serving as synchronizing recesses—in order to facilitate switching and entry by the teeth of the internal splines of the shifting sleeve (34) into the tooth gaps of the splined shaft profiles.

11. The rotary hammer as recited in claim 1,
wherein
each of the teeth in the internal spline profile of the shifting sleeve (34) has a partial tooth width reduction of approximately 1 to 2 mm on both end faces; the teeth in the splined shaft profile of the wobble gear (38) and the output gear (35) have no tooth width reduction.

12. The rotary hammer as recited in claim 1
wherein
an intermediate flange (25) is mounted between the motor (16) and the transmission (26), in which one end of the intermediate shaft (28) is rotatably supported, preferably via a needle bearing.

13. The rotary hammer as recited in claim 1,
wherein
a single-piece, particularly U-bent shift plate (54) serves as shifting means; one of the U-legs serves as an engaging fork (52) and the other U-leg serves as a locking fork (56).

14. The rotary hammer as recited in claim 13,
wherein
the locking fork (56) has an internal spline profile (58), with which it is capable of being brought into locking engagement with the splined shaft profile of the output gear (35), particularly in the switch setting of the exclusively reciprocating motion of the output shaft (46).

15. The rotary hammer as recited in claim 3,
wherein
the wobble gear (38)—on which a swash plate (40) with a wobble finger (42) is mounted—is rotatably supported on the intermediate shaft (28) adjacent to the driving gear (30); entrained gear (32) is non-rotatably mounted axially adjacent to wobble gear (38); output gear (35) is rotatably mounted axially adjacent to entrained gear (32) and is secured axially via an antifriction bearing (45) mounted on the end of the intermediate shaft (28) in an axially fixed manner; the entrained gear (32) is enclosed by the shifting sleeve (34) in a rotatably driveable and axially displaceble manner, and the output gear (35) of the intermediate shaft (28) meshes with the output gear (48) of the output shaft (46).
